(19) United States
(12) Patent Application Publication
(10) Pub. No.: US 2015/0043849 A1
(43) Pub. Date: Feb. 12, 2015

(54) THERMAL MANAGEMENT BEARING ASSEMBLIES, APPARATUSES, AND MOTOR ASSEMBLIES USING THE SAME

(71) Applicant: US Synthetic Corporation, Orem, UT (US)

(72) Inventors: S. Barrett Peterson, Orem, UT (US); Jair J. Gonzalez, Provo, UT (US); Timothy N. Sexton, Genola, UT (US); Brigham J. Kindell, Spanish Fork, UT (US)

(73) Assignee: US Synthetic Corporation, Orem, UT (US)

(21) Appl. No.: 13/963,777

(22) Filed: Aug. 9, 2013

(51) Int. Cl. F16C 17/22; F16C 17/04; F16C 43/02; E21B 4/00

(52) U.S. Cl. CPC F16C 17/22; E21B 4/003; F16C 17/04; F16C 43/02
USPC 384/420; 29/898

(57) ABSTRACT

Bearing assemblies, apparatuses, and motor assemblies using the same are disclosed. In an embodiment, the bearing assembly may include a support ring extending circumferentially about a central axis and a plurality of superhard bearing elements distributed circumferentially about the central axis. Each of the superhard bearing elements may be mounted to the support ring and may include a bearing surface. The bearing assembly may further include one or more thermal management elements including at least one of one or more thermally conductive structures or at least one of the superhard tables exhibiting a non-uniform thickness structured to promote cooling thereof during use. The one or more thermal management elements are in thermal communication one or more bearing surfaces and are configured to promote heat transfer away from the one or more of the bearing surfaces.

### BACKGROUND

Subterranean drilling systems that employ downhole drilling motors are commonly used for drilling boreholes in the earth for oil and gas exploration and production. A subterranean drilling system typically includes a downhole drilling motor that is operably connected to an output shaft. A pair of thrust-bearing apparatuses also can be operably coupled to the downhole drilling motor. A rotary drill bit configured to engage a subterranean formation and drill a borehole is connected to the output shaft. As the borehole is drilled with the rotary drill bit, pipe sections may be connected to the subterranean drilling system to form a drill string capable of progressively drilling the borehole to a greater depth within the earth.

Each thrust-bearing apparatus includes a stator that does not rotate relative to the motor housing and a rotor that is attached to the output shaft and rotates with the output shaft. The stator and rotor each includes a plurality of bearing elements that may be fabricated from polycrystalline diamond compacts (“PDCs”) that provide diamond bearing surfaces that bear against each other during use.

In operation, high-pressure drilling fluid may be circulated through the drill string and power section of the downhole drilling motor, usually prior to the rotary drill bit engaging the bottom of the borehole, to generate torque and rotate the output shaft and the rotary drill bit attached to the output shaft. When the rotary drill bit engages the bottom of the borehole, a thrust load is generated, which is commonly referred to as “on-bottom thrust,” that tends to compress and is carried by, at least in part, one of the thrust-bearing apparatuses. Fluid flow through the power section may cause what is commonly referred to as “off-bottom thrust,” which is carried by, at least in part, the other thrust-bearing apparatus. The drilling fluid used to generate the torque for rotating the rotary drill bit exits openings formed in the rotary drill bit and returns to the surface, carrying cuttings of the subterranean formation through an annular space between the drilled borehole and the subterranean drilling system. Typically, a portion of the drilling fluid is diverted by the downhole drilling motor to help cool and lubricate the bearing elements of the thrust-bearing apparatuses.

Overheating or thermal loading of the bearing elements may lead to premature failure of the bearing apparatus. For instance, the bearing elements may include a superhard material, which may deteriorate and/or degrade, and experience failure at elevated temperatures that may result from such heating. In addition, thermal expansion of one or more of the bearing elements may increase forces on the bearing elements during operation. In some instances, increased structural loading of the bearing elements may lead to deformation and/or fracturing of the bearing assembly and/or components or elements thereof. In any case, insufficient heat removal from the superhard bearing elements may prematurely cause damage to the thrust-bearing apparatuses.

Therefore, manufacturers and users of bearing apparatuses and subterranean drilling systems continue to seek improved thermal management designs and manufacturing techniques.

### SUMMARY

Various embodiments of the invention relate to bearing assemblies, bearing apparatuses and motor assemblies that include one or more thermal management elements. In an embodiment, the bearing assembly may include a support ring extending circumferentially about a central axis and a plurality of superhard bearing elements distributed circumferentially about the central axis. Each of the superhard bearing elements may be mounted to the support ring and may include a bearing surface. The bearing assembly may further include one or more thermal management elements including at least one of one or more thermally conductive structures or at least one of the superhard tables exhibiting a non-uniform thickness structured to promote cooling thereof during use. The one or more thermal management elements are in thermal communication one or more bearing surfaces and are configured to promote heat transfer away from the one or more of the bearing surfaces.

In an embodiment, a bearing apparatus may include a first bearing assembly having a first support ring extending circumferentially about a central axis and a first plurality of superhard bearing elements distributed circumferentially about the central axis. Each of the first superhard bearing elements may be mounted to the first support ring and may include a superhard table having a bearing surface. The first bearing assembly may further include one or more thermal management elements including at least one of one or more thermally conductive structures or at least one of the superhard tables exhibiting a non-uniform thickness structured to promote cooling thereof during use. The one or more thermal management elements are in thermal communication with one or more of the bearing surfaces and are configured to promote heat transfer from the one or more of the bearing surfaces. The bearing apparatus may further include a second support ring extending circumferentially about the central axis and a second plurality of superhard bearing elements generally opposed the first plurality of superhard bearing elements of the first bearing assembly. Each of the second plurality of superhard bearing elements may be attached to the second support ring.

In an embodiment, a method of manufacturing a superhard bearing element may include removing a portion of substrate and replacing the removed portion of the substrate with a thermally-conductive element that is more thermally conductive than the substrate. The method may further include attaching a superhard table to a interfacial surface of the substrate to form the superhard bearing element.

Other embodiments include downhole motors for use in drilling systems and subterranean drilling systems that may utilize any of the disclosed bearing apparatuses.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments, wherein identical reference numerals refer to identical or similar elements or features in different views or embodiments shown in the drawings.

FIG. 1A is an isometric view of a thrust-bearing assembly according to an embodiment.

FIG. 1B is a top plan view of the thrust-bearing assembly shown in FIG. 1A.

FIG. 1C is an isometric cutaway view taken along line 1C-1C of the thrust-bearing assembly shown in FIG. 1B.

FIG. 1D is a cross-sectional view of one of the superhard bearing elements removed from the thrust-bearing assembly shown in FIG. 1A.

FIGS. 2A through 2C are cross-sectional views of a superhard bearing element according to another embodiment.

FIG. 3 is a cross-sectional view of a superhard bearing element according to another embodiment.

FIG. 4A is an exploded view of a superhard bearing element according to another embodiment.

FIG. 4B is a cross-sectional view of the superhard bearing element shown in FIG. 4A.

FIG. 4C is a cross-sectional view of the superhard bearing element shown in FIG. 4A attached to a support ring according to another embodiment.

FIG. 4D is an exploded view of a superhard bearing element according to another embodiment.

FIG. 4E is a cross-sectional view of the superhard bearing element shown in FIG. 4D.

FIG. 5A is an isometric view of a superhard bearing element according to another embodiment.

FIG. 5B is a top view of the superhard bearing elements shown in FIG. 5A attached to a support ring according to an embodiment.

FIG. 5C is an isometric view of a superhard bearing element according to another embodiment.

FIGS. 6A and 6B are isometric cutaway views of thrust-bearing assemblies according to various embodiments.

FIG. 7A is an isometric view of thrust-bearing apparatus according to an embodiment.

FIG. 7B is a partial cross-sectional view of the thrust-bearing apparatus shown in FIG. 7A taken along line 7B-7B.

FIG. 8A is an isometric view of a radial bearing assembly according to an embodiment.

FIG. 8B is an isometric cutaway view of the radial bearing assembly shown in FIG. 8A.

FIGS. 8C and 8D are plan views of embodiments of superhard bearing elements that can be used in the radial bearing assembly shown in FIGS. 8A and 8B.

FIG. 9 is an isometric cutaway view of a radial bearing apparatus that may utilize any of the disclosed radial bearing assemblies according to various embodiments.

FIG. 10 is a schematic isometric cutaway view of a subterranean drilling system that may utilize any of the disclosed bearing assemblies according to various embodiments.

### DETAILED DESCRIPTION

Embodiments of the invention relate to bearing assemblies, bearing apparatuses and motors, pumps, or other mechanical assemblies that include one or more heat management features. During use, conventional superhard bearing elements may not be able to effectively cool. Embodiments of the invention contemplate that at least some of the superhard bearing elements and/or the support ring may be provided with one or more heat management features to promote cooling during use.

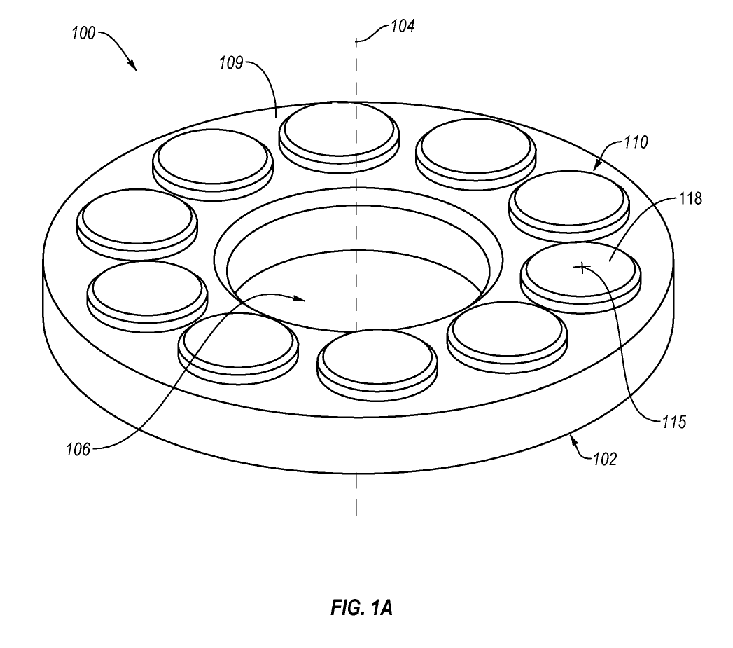

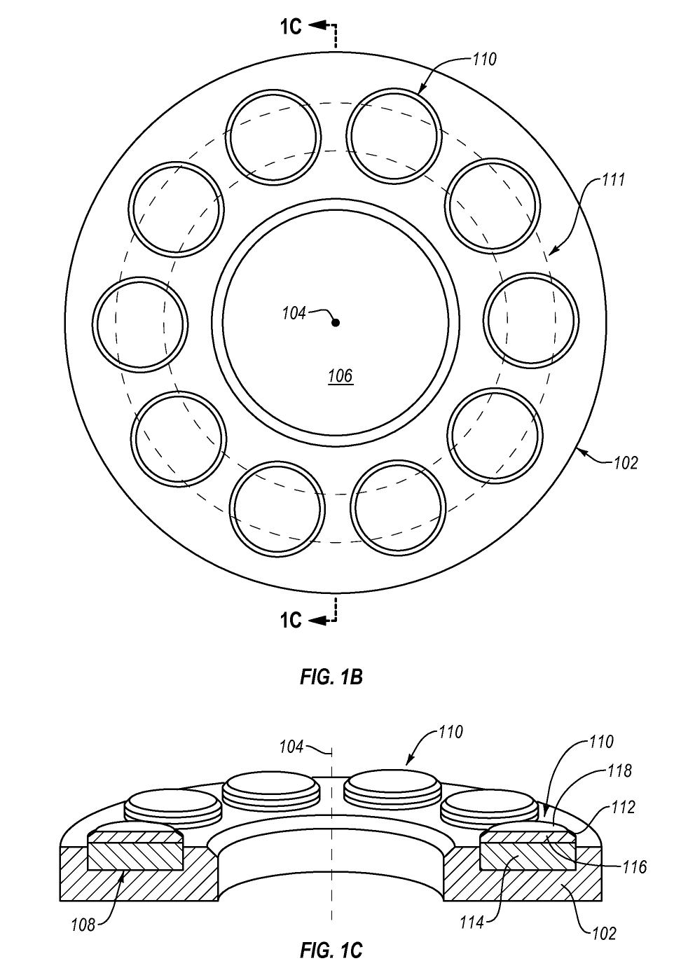

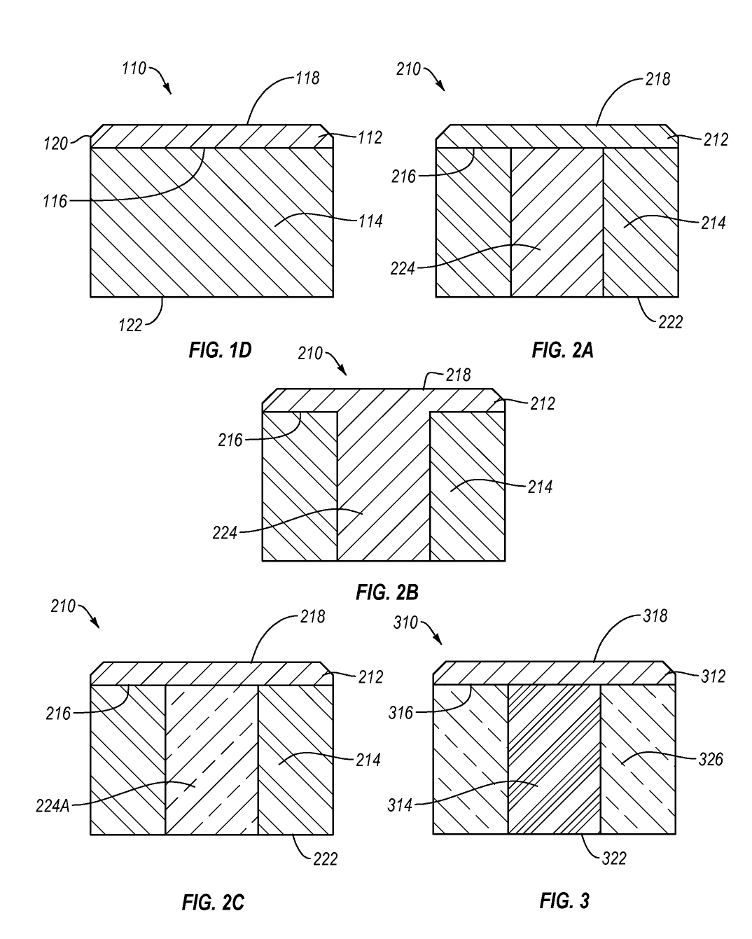

FIGS. 1A and 1B are isometric and top plan views of a thrust-bearing assembly 100 according to an embodiment. The thrust-bearing assembly 100 may form a stator or a rotor of a thrust-bearing apparatus used in a subterranean drilling system. As shown in FIGS. 1A and 1B, the thrust-bearing assembly 100 may include a support ring 102 defining an opening 106 through which a shaft (not shown) of, for example, a downhole drilling motor may extend. The support ring 102 may be made from a variety of different materials. For example, the support ring 102 may comprise a metal, alloy steel, a metal alloy, carbon steel, stainless steel, tungsten carbide, or any other suitable metal or conductive or non-conductive material. The support ring 102 may include a plurality of recesses 108 (shown in FIG. 1C) formed therein.

The thrust-bearing assembly 100 further may include a plurality of superhard bearing elements 110. Each of the superhard bearing elements 110 may be partially disposed in a corresponding one of the recesses 108 of the support ring 102 and secured partially therein via brazing, press-fitting, threadedly attaching, fastening with a fastener, combinations of the foregoing, or another suitable technique. As illustrated, the superhard bearing elements 110 may be distributed circumferentially about the central axis 104 in a single row. In other embodiments, the superhard bearing elements 110 may be circumferentially distributed in two rows, three rows, four rows, or any other number of rows. In the illustrated embodiment, gaps 109 or other offsets may be located between adjacent ones of the superhard bearing elements 100. In an embodiment, at least one of, some of, or all of the gaps 109 may exhibit a width of about 0.00020 inches to 0.50 inches, such as about 0.00040 inches to 0.0010 inches, about 0.00040 inches to 0.080 inches, or 0.1 inches to 0.2 inches, 0.3 inches to 0.4 inches, or about 0.40 inches to 0.50 inches. In other embodiments, the gaps 109 may substantially be zero.

Referring to FIGS. 1C and 1D, at least some of the superhard bearing elements 110 may comprise a superhard table 112 and a substrate 114 having an interfacial surface 116 that is bonded to the superhard table 112. The substrate 114 may include a rear face 122 remote from the interfacial surface 116. The superhard table 112 may define a bearing surface 118 and a peripheral surface 120. In an embodiment, the bearing surfaces 118 of the superhard tables 112 may collectively form a superhard bearing surface of the thrust-bearing assembly 100.

In an embodiment, one or more of the superhard bearing elements 110 may have a generally cylindrical shaped body. While the superhard bearing elements 110 are shown in having a generally cylindrical shaped body, in other embodiments, one or more of the superhard bearing elements 110 may include a generally rounded rectangular body, a generally oval shaped body, a generally wedge shaped body, or any other suitable shaped body. Optionally, one or more of the superhard bearing elements 110 may exhibit a peripherally extending edge chamfer. However, in other embodiments, the edge chamfer may be omitted.

In any of the embodiments disclosed herein, the superhard bearing elements 110 may at least partially comprise one or more superhard materials, such as natural diamond, sintered polycrystalline diamond (“PCD”), polycrystalline cubic boron nitride, diamond grains bonded together with silicon carbide, or combinations of the foregoing. For example, the superhard table 112 may comprise polycrystalline diamond and the substrate 114 may comprise cobalt-cemented tungsten carbide. Furthermore, in any of the embodiments disclosed herein, the polycrystalline diamond table may be leached to at least partially remove or substantially completely remove a metal-solvent catalyst (e.g., cobalt, iron, nickel, or alloys thereof) that was used to initially sinter precursor diamond particles to form the polycrystalline diamond. In another embodiment, an infiltrant used to re-infiltrate a preformed leached polycrystalline diamond table may be leached or otherwise removed to a selected depth from a bearing surface. Moreover, in any of the embodiments disclosed herein, the polycrystalline diamond may be un-leached and include a metal-solvent catalyst (e.g., cobalt, iron, nickel, or alloys thereof) that was used to initially sinter the precursor diamond particles that form the polycrystalline diamond and/or an infiltrant used to re-infiltrate a preformed leached polycrystalline diamond table. Examples of methods for fabricating the superhard bearing elements and superhard materials and/or structures from which the superhard bearing elements can be made are disclosed in U.S. Pat. Nos. 7,866,418; 7,998,573; 8,034,136; and 8,236,074; the disclosure of each of the foregoing patents are incorporated herein, in their entirety, by this reference.

The diamond particles that may be used to fabricate the superhard table 112 in a high-pressure/high-temperature process (“HPHT”) may exhibit a larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the diamond particles may include a portion exhibiting a relatively larger size (e.g., 40 μm, 30 μm, 20 μm, 15 μm, 12 μm, 10 μm, 8 μm) and another portion exhibiting at least one relatively smaller size (e.g., 6 μm, 5 μm, 4 μm, 3 μm, 2 μm, 1 μm, 0.5 μm, less than 0.5 μm, 0.1 μm, less than 0.1 μm). In an embodiment, the diamond particles may include a portion exhibiting a relatively larger size between about 10 μm and about 40 μm and another portion exhibiting a relatively smaller size between about 1 μm and about 4 μm. In some embodiments, the diamond particles may comprise three or more different sizes (e.g., one relatively larger size and two or more relatively smaller sizes), without limitation. Upon HPHT sintering the diamond particles to form the polycrystalline diamond, the polycrystalline diamond may, in some cases, exhibit an average grain size that is the same or similar to any of the diamond particles sizes and distributions discussed above. Additionally, in any of the embodiments disclosed herein, the superhard bearing elements 112 may be free-standing (e.g., substrateless) and formed from a polycrystalline diamond body that is at least partially or fully leached to remove a metal-solvent catalyst initially used to sinter the polycrystalline diamond body. In an embodiment, the leached polycrystalline diamond body may be formed to exhibit a porosity of about 1%-10% by volume. Optionally, the leached pores of the polycrystalline diamond body may be impregnated with lubricant to assist in minimizing friction caused by contact between opposing bearing surfaces. In other embodiments, the polycrystalline diamond body may exhibit a selected porosity that is higher or lower.

The substrate 116 may be formed from any number of different materials. For example, the substrate 116 may comprise a cemented carbide substrate, such as tungsten carbide, tantalum carbide, vanadium carbide, niobium carbide, chromium carbide, titanium carbide, or combinations of the foregoing carbides cemented with iron, nickel, cobalt, or alloys thereof. In an embodiment, the cemented carbide substrate may comprise a cobalt-cemented tungsten carbide substrate. In other embodiments, the substrate 116 may be omitted and the superhard bearing element 110 may be substantially entirely a superhard material, such as a PCD body that has been leached to deplete metal-solvent catalyst therefrom or may be an un-leached PCD body.

Under certain operational conditions, relatively high forces and/or frictional loads experienced by one or more of the superhard bearing elements 110 may damage one or more of the superhard bearing elements 110. For example, accelerated and/or uneven heating or thermal loading of the superhard bearing elements 110 may lead to hot spots that can cause premature failure of the thrust-bearing assembly 100. Typically, these hot spots form near or proximate to the center 115 of the superhard bearing surface 118. As the thrust-bearing assembly 100 rotates about the central axis 104, hot spots may form on the superhard bearing elements 110. Such hot spots can result in thermal damage that can progress from one superhard bearing element 110 to another along a degradation path 111 (shown in FIG. 1B) extending about the central axis 104. For example, the superhard table 112 may comprise polycrystalline diamond. Consequently, at temperatures above around 700° C. the polycrystalline diamond may degrade under operating conditions, which could lead to failure of the superhard bearing elements 110 that progresses from one superhard bearing element 110 to another, and, thus, the thrust-bearing assembly 100. Accordingly, dissipating heat from such hot spots and/or other portions of the superhard table 112 may prolong the useful life of the thrust-bearing assembly 100.

Any of the embodiments herein may include one or more thermal management elements or features. The one or more thermal management features may be configured to effectively provide heat dissipation and/or heat distribution for superhard bearing elements, bearing assemblies, bearing apparatuses include such bearing assemblies, and methods of operating such assemblies and apparatuses. In an embodiment, the one or more thermal management features may be configured to redistribute thermal load from one superhard bearing element to another. As such, the collective heat capacity of the superhard bearing elements may be utilized to help absorb heat produced during operation of the bearing assembly. In other embodiments, the one or more thermal management features may be configured to help dissipate heat from the superhard bearing elements by increasing convective heat transfer between the superhard bearing elements and the cooling fluid. In other embodiments, the one or more thermal management features may be configured to dissipate heat away from the superhard bearing elements.

For example, in an embodiment, the substrate 114 may include one or more thermally-conductive materials. Examples of thermally-conductive materials may include, but are not limited to, copper, copper alloys, aluminum and aluminum alloys, brass, bronze, gold, silver, graphite, diamond, polycrystalline diamond, high grade tungsten carbide, combinations thereof, or the like. In an embodiment, one or more portions of the substrate 114 may be made from a material exhibiting a thermal-conductivity that is about 1.6 to about 50 times (e.g., about 5 to about 25 times, about 15 to about 20 times, or about 18 to about 25 times) greater than that of the material from which the support ring 102 may be made (e.g., high strength steel). In other embodiments, one or more portions of the substrate 114 may be made from a material exhibiting a thermal conductivity that is more than about 20 times or more, about 40 times or more, or about 60 times or more than that of the material from which the support ring 102 may be made. In another embodiment, one or more portions of the substrate 114 may be made from a material exhibiting a thermal conductivity that is between about 10 to about 20 times, about 20 to about 40 times, or about 40 to about 60 times greater than that of the material from which the support ring 102 may be made. In an embodiment, one or more portions of the substrate 116 may include one or more thermally-conductive materials that exhibit a thermal-conductivity at 25° C. of about 80 W/m*K to about 2000 W/m*K, such as about 300 W/m*K to about 1800 W/m*K, about 350 W/m*K to about 450 W/m*K, or about 1500 W/m*K to about 1850 W/m*K. In other embodiments, one or more portions of the substrate 114 may include one or more high grade tungsten carbide materials. “High grade tungsten carbide material,” as used herein, is a tungsten carbide material that exhibits a thermal conductivity greater than 70 W/m*K at about 25° C. For example, at least a portion of the substrate 114 may include one or more high grade tungsten carbide materials having a thermal conductivity at about 25° C. greater than about 80 W/m*K, about 90 W/m*k, or about 100 W/m*K. In other embodiments, at least a portion of the substrate 114 may include one or more high grade tungsten carbide materials having a thermal conductivity between about 80 W/m*K and about 120 W/m*K, about 85 W/m*K and about 110 W/m*K, or about 90 W/m*K and about 100 W/m*K. In other embodiments, at least a portion of the substrate 114 may include one or more high grade tungsten carbide materials exhibiting a thermal conductivity greater than 70 W/m*K.

The substrate 114 including the one or more thermally-conductive materials may promote heat transfer from the superhard table 112. For example, the substrate 114 comprising the one or more thermally-conductive materials may provide thermal communication between the support ring 102 and the superhard table 112. Accordingly, heat (which may be generated due to contact between the bearing surfaces 118 and opposing bearing surfaces) may be transferred from the superhard table 112 to the support ring 102 via the substrate 114. Moreover, as fluid flows about the superhard bearing elements 110, the fluid may remove heat from the superhard bearing elements 110, thereby cooling the superhard bearing elements 110. The substrate comprising the one or more thermally-conductive materials may increase the rate of heat transfer between the superhard bearing elements 110 and fluid (e.g., through convection).

In other embodiments, the substrate 114 may include one or more discrete portions including one or more thermal management features. For example, FIGS. 2A through 2C are cross-sectional views of a superhard bearing element 210 including a thermally-conductive core or optional post portion. It should be noted that the principles, embodiments, and/or features of the superhard bearing element 210 may be employed with any of the embodiments and/or features described with respect to FIGS. 1A through 1D.

The superhard bearing element 210 may include a superhard table 212 and a substrate 214 having an interfacial surface 216 that is bonded to the superhard table 212 and a rear face 222 remote from the interfacial surface 216. The superhard table 212 may define a bearing surface 218. The substrate 214 may be made from the same materials as described herein with respect to the substrate 114. For example, in an embodiment, the substrate 214 comprises a cemented carbide substrate. In other embodiments, the substrate 214 comprises high-grade tungsten carbide. In an embodiment, the superhard table 212 may be made from the same materials as described herein with respect to the superhard table 112. For example, in an embodiment, the superhard table 212 may comprise polycrystalline diamond.

A core portion 224 including one or more thermally-conductive materials may be positioned within the substrate 214 of the superhard bearing element 210. The core portion 224 may include any number of suitable thermally-conductive materials including, but not limited to, copper, copper alloys, polycrystalline diamond, aluminum and aluminum alloys, PCD, combinations thereof, or any other suitable thermally-conductive material. In an embodiment, the core portion 224 may provide thermal communication between the support ring 102 (shown in FIG. 1A) and the superhard bearing table 212. For example, the core portion 224 may be sized and configured to thermally and physically contact, couple with, or interconnect the superhard table 212 and the rear face 222 and/or the support ring 102. Accordingly, heat may be transferred from the superhard table 212 to the support ring 102 via the core portion 224. Moreover, the portion of the substrate 214 surrounding the core portion 224 alone and/or in combination with the core portion 224 may provide support to the superhard table 212. For example, the forces/pressure applied to the bearing surface 218 may be transferred through the superhard table 212, to the tungsten carbide portion of the substrate 214, and to the support ring 102. In other embodiments, the core portion 224 may include a superhard thermally-conductive material (e.g., PCD) such that forces/pressure applied to the bearing surface 218 may be transferred through the superhard table 212, to the superhard core portion 224 and/or tungsten carbide portion of the substrate 214, and to the support ring 102.

As discussed above, accelerated and/or uneven heating may lead to hot spots in the superhard bearing elements that can progress along a degradation path 111 (shown in FIG. 1B) or another path about the support ring 102. In an embodiment, the core portions 224 may be positioned within the superhard bearing elements 210 such that when the superhard bearing elements 210 are attached to the support ring 102, the core portions 224 are substantially circumferentially aligned (e.g., in reference to the degradation zone 111). Consequently, the core portions 224 may help maintain the temperature of the superhard table 212 in these hot spots below detrimental temperatures by dissipating heat away from these hot spots.

The core portion 224 may be separately formed, inserted, press-fitted, brazed, and/or otherwise secured within the substrate 214 before or after the superhard table 212 is attached to the first interfacial surface 216. For example, the substrate 214 may initially comprise cobalt-cemented tungsten carbide. After the superhard table 212 is formed or otherwise bonded to the substrate 214, a portion of the substrate 214 may be removed, and the core portion 224 may replace such removed portion of the substrate 214. For example, a recess may be created in the substrate 214 and the core portion 224 may be inserted and press-fitted, brazed, and/or otherwise secured within the recess. The recess may be formed in any suitable manner. For example, the recess may be formed in the substrate 214 via electro-discharge machining (“EDM”), laser-cutting, computer numerical control (“CNC”) milling, grinding, combinations thereof, or otherwise suitable techniques. In an embodiment, the recess may be generally centrally located in the substrate 214. In other embodiments, the recess may be offset from the center of the substrate 214 and/or may be located toward a trailing, a leading, or other edge of the superhard bearing element 210. The recess may exhibit any suitable shape. For example, the recess may exhibit a generally rectangular shape, a generally curved shape, an irregular shape, or any other suitable shape. In an embodiment, the core portion 224 may be in physical contact with the superhard table 212.

While the core portion 224 is shown extending between the interfacial surface 216 and the rear face 222, in other embodiments, the core portion 224 may be sized and configured to extend only a portion of the distance between the interfacial surface 216 and the rear face 222 of the substrate 214. Moreover, while one core portion 224 is illustrated, in other embodiments, the superhard bearing element 210 may include two, three, four, or any other number of suitable core portions. For example, in an embodiment, the substrate 214 may include a first core portion comprising a first thermally-conductive material and a second core comprising a second thermally-conductive material that is different than the first thermally-conductive material.

As discussed above, the core portion 224 may include any number of suitable thermally-conductive materials. For example, the core portion 224 may comprise polycrystalline diamond. In an embodiment, as shown in FIG. 2B, the PCD core portion 224 may be integrally formed with the superhard table 212. For example, a metal-solvent catalyst may be infiltrated from the cemented carbide substrate 214 during the HPHT processing to catalyze formation of the PCD that forms the superhard table 212 and the PCD core portion 224. In other embodiments, as shown in FIG. 2A, the PCD core portion 224 may be formed separately from the superhard table 212. For example, the superhard table 212 may be pre-sintered PCD and the PCD portion 224 may be separately formed and bonded to the superhard table 212 during HPHT bonding to the superhard table 212 to the substrate 214.

In other embodiments, the superhard bearing element 210 may include a core portion 224A comprising copper or copper alloys as shown in FIG. 2C. The substrate 214 may at least partially enclose and protect the core portion 224A from certain harsh environments. Hence, in at least one example, the core portion 224A may promote efficient heat transfer from the superhard table 212 and the tungsten carbide portion of the substrate 214 may provide sufficient support to the superhard table 212. In yet other embodiments, the core portion 224 may include two or more materials. For example, in an embodiment, the core portion 224 may comprise a PCD core surrounding by one or more layers of copper or other thermally-conductive material.

FIG. 3 is a cross-sectional view of a superhard bearing element 310 including thermally-conductive outer portion. It should be noted that the principles, embodiments, and/or features of the superhard bearing element 310 may be employed with any of the embodiments and/or features described with respect to FIGS. 1A through 2B.

The superhard bearing element 310 may include a superhard table 312 and a substrate 314 having an interfacial surface 316 that is bonded to the superhard table 312 and a rear face 322 remote from the interfacial surface 316. The superhard table 312 may define a bearing surface 318. In an embodiment, the substrate 314 may include a lateral surface extending between the interfacial surface 316 and the rear face 322. The substrate 314 may be made from the same materials as described with respect to substrate 114. For example, in an embodiment, the substrate 314 may comprise a cemented carbide substrate or high-grade tungsten carbide. The superhard table 312 may be formed from the same materials as described with respect to superhard table 112. For example, the superhard table 312 may comprise polycrystalline diamond.

As shown in FIG. 3, an outer portion 326 including one or more thermally-conductive materials may be positioned to surround at least a portion of the substrate 314 of the superhard bearing element 310. The outer portion 326 may comprise any number of thermally-conductive materials. For example, the outer portion 326 may comprise copper or copper alloys, polycrystalline diamond, graphite, graphoil, aluminum or aluminum alloys, combinations thereof, or any other suitable thermally-conductive materials. In an embodiment, the outer portion 326 may comprise an annular member surrounding at least a portion of the lateral surface of the substrate 314. In an embodiment, the outer portion 326 may comprise a sleeve-like member positioned on the substrate 314. In other embodiments, the outer portion 326 may comprise a coating formed and/or bonded to the substrate 314. In yet other embodiments, the outer portion 326 may comprise a mask, one or more rod-like members, a sheath, a casing, a shell, combinations thereof, or any other suitable member. In an embodiment, the outer portion 326 may be unitary. In other embodiments, the outer portion 326 may include a plurality of portions or layers.

The outer portion 326 may be separately formed, infused, inserted and/or press-fitted, brazed, and/or otherwise secured to the substrate 314. For example, after the superhard table 312 is formed or otherwise bonded to the substrate 314, an outer portion of the substrate 314 may be removed. The portion of the substrate 314 may be removed via EDM, laser-cutting, CNC milling, grinding, combinations thereof, or other suitable techniques. The outer portion 326 may replace such removed portion of the substrate 314. In an embodiment, the outer portion 326 may exhibit an outer diameter that is substantially the same as an outer diameter of the superhard table 312. In other embodiments, the outer portion 326 may exhibit an outer diameter that is less than or greater than an outer diameter of the superhard table 312. Moreover, in an embodiment, the outer diameter of the outer portion 326 may be substantially constant. In other embodiments, the outer diameter of the outer portion 326 may vary.

In an embodiment, the outer portion 326 may provide thermal communication between the support ring 102 (shown in FIG. 1A), the substrate 314, and/or the superhard table 312. Accordingly, heat may be transferred from the superhard table 312 to the support ring 102 via the outer portion 326. Moreover, as fluid flows about the outer portion 326, the fluid may remove heat from the superhard bearing elements 310, thereby cooling the superhard bearing elements 310. Thus, the thermally-conductive outer portion 326 may increase the rate of heat transfer between the superhard bearing elements 310 and the fluid (e.g., through convection).

The superhard tables may also be thermally-conductive. For instance, as mentioned above, the superhard tables may comprise polycrystalline diamond. Accordingly, the superhard tables of the superhard bearing elements may help in dissipating heat from the thrust-bearing assemblies. The superhard tables may have any suitable thickness. Accordingly, increasing the amount of surface of the superhard tables that is in thermal communication with fluid and/or the support ring 102 can increase the rate of heat transfer therebetween (e.g., through convection).

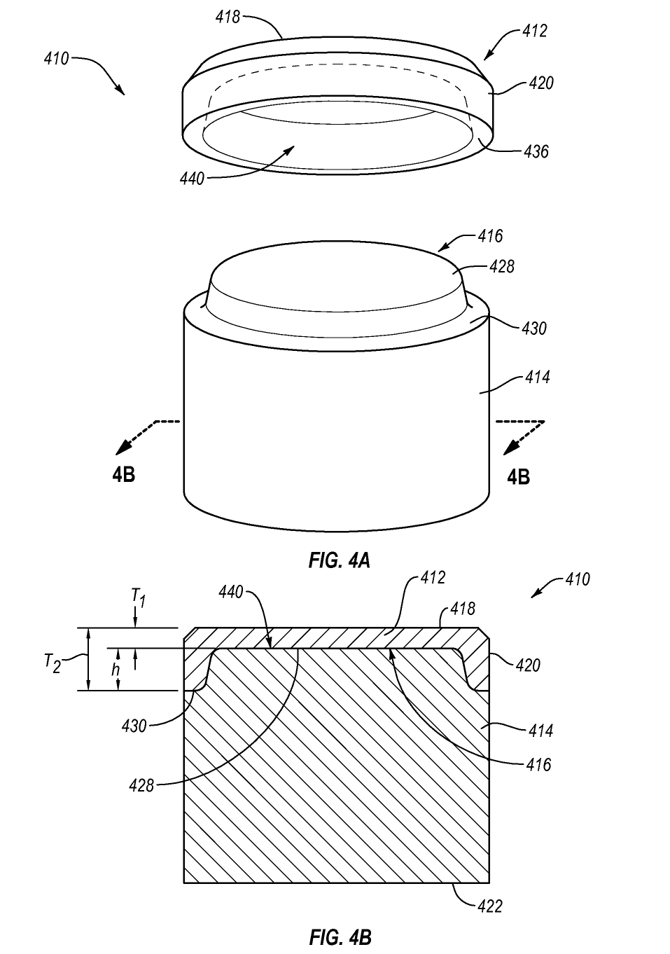

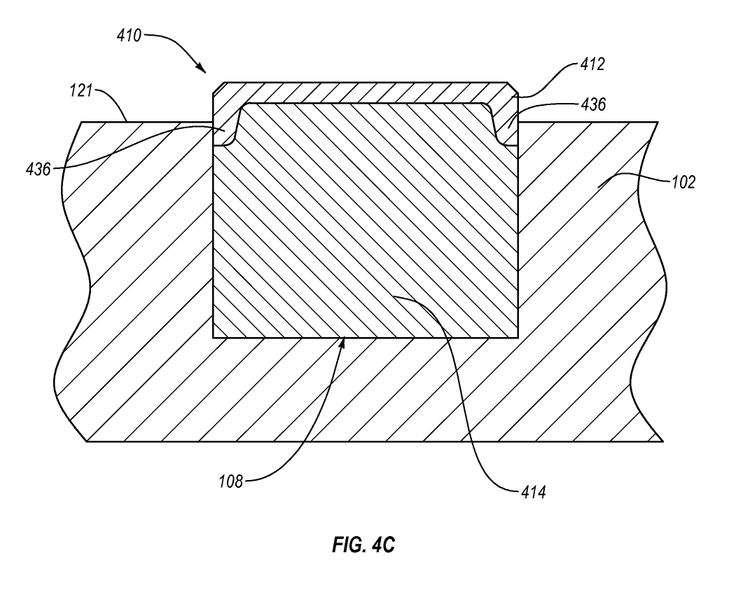

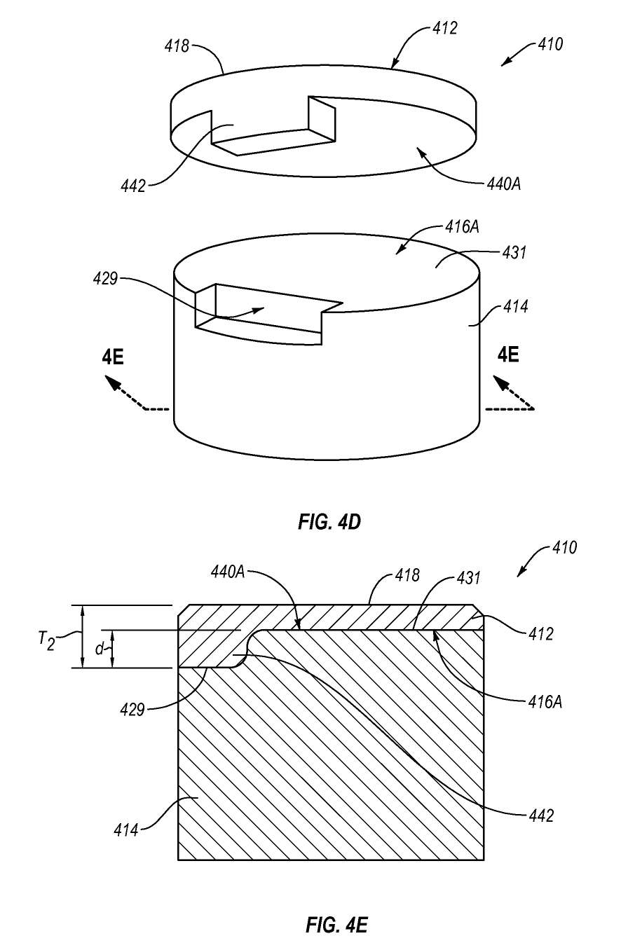

For example, FIGS. 4A and 4B are exploded and cross-sectional views, respectively, of a superhard bearing element 410 including a superhard table having a varying thickness. It should be noted that the principles, embodiments, and/or features of the superhard bearing element 410 may be employed with any of the embodiments and/or features described with respect to FIGS. 1A through 3.

The superhard bearing element 410 includes a superhard table 412 and a substrate 414 having an interfacial surface 416 that is bonded to the superhard table 412. The substrate 414 may include a rear face 422 remote from the interfacial surface 416. The superhard table 412 may define a bearing surface 418 and a peripheral surface 420. The substrate 414 may be formed from the same materials as described herein with respect to substrates 114, 214, and 314. For example, the substrate 414 may comprise a cemented carbide substrate, such as a cobalt-cemented tungsten carbide substrate. In other embodiments, the substrate 414 may include a PCD core portion surrounded by tungsten carbide and/or copper. In yet other embodiments, the substrate 414 may include a tungsten carbide portion surrounded by a thermally-conductive outer portion.

In an embodiment, a top surface of substrate 414 may be at least partially covered by the superhard table 412. For example, the superhard table 412 may surround at least a portion of the lateral surface of the substrate 414. Consequently, the superhard table 412 may be thinner closer to the center of the superhard bearing element 410 and may be thicker closer to the outer edge(s) of the superhard bearing element 410. Such a configuration may increase the amount of surface of the superhard table 412 that is in thermal communication with the fluid and/or the support ring 102.

For example, in an embodiment, an interfacial surface 416 of the substrate 414 includes a raised region 428 and a peripheral region 430 extending about the raised region 428. The raised region 428 may project about the peripheral region 430 to a distance “h.” For example, the distance h may be about 0.001 inches to about 0.40 inches, about 0.03 inches to about 0.30 inches, about 0.05 inches to about 0.25 inches, or about 0.08 inches to about 0.20 inches. In an embodiment, the distance “h” may be about 0.1 inches to about 0.2 inches, about 0.2 inches to about 0.3 inches, or about 0.3 inches to about 0.4 inches. In the illustrated embodiment, the raised region 428 is a body exhibiting a generally rectangular cross-sectional geometry that is bonded to the superhard table 412. However, the raised region 428 may exhibit other selected geometries, such as a raised body having an ovoid geometry, a raised body having an elliptical geometry, a raised body having a generally semicircular cross-sectional geometry, a truncated convex body, or another suitable body. While a raised region 428 is illustrated, in other embodiments, the interfacial surface 416 may include a recessed region surrounded by the peripheral region 430, or raised regions and recessed regions, combinations thereof, or the like.

The superhard table 412 may be formed from the same materials as described herein with respect to superhard table 112. For example, the superhard table 412 may comprise one or more thermally conductive materials (e.g., polycrystalline diamond). As shown in FIGS. 4A and 4B, the superhard table 412 exhibits a non-uniform thickness over the interfacial surface 416 and may include an interfacial surface 440 that may be configured to correspond to the topography of the interfacial surface 416 of the substrate 414. For example, an outer region 436 of the superhard table 412 may fill the cavity defined by the peripheral region 430 of the substrate 414. Consequently, the superhard table 412 may be thinner closer to a center region of the superhard bearing element 410 and may be thicker closer to the outer edge(s) of the outer region 436.

For example, in an embodiment, a thickness “T₁” is the minimum thickness of the superhard table 412 and is located immediately over the upper most portion of the raised region 428 as measured from the bearing surface 414. However, the thickness T₁ may be used to represent any cross-sectional thickness of the superhard table 412 over the raised region 428. The thickness T₁ may be about 0.10 inches or less, about 0.07 inches or less, about 0.06 inches or less, about 0.05 inches or less, or about 0.03 inches or less. In an embodiment, the thickness T₁ may be about 0.8 inches to about 0.1 inches, about 0.1 inches to about 0.15 inches, or about 0.1 inches to about 0.12 inches. In other embodiments, the thickness T₁ may be larger or smaller.

A maximum thickness T₂ of the superhard table 412 may be located in the outer, annular region 436 of the superhard table 412 immediately over the peripheral region 430 as measured from the bearing surface 414. The maximum thickness T₂ of the superhard table 412 may be about the same, about 1.1 to about 6 times greater, or about 2 to about 5 times greater than the thickness T₁. In other embodiments, the ratio of the maximum thickness T₂ to the minimum thickness T₁ may be larger or smaller. In an embodiment, the maximum thickness T₂ may be about 0.125 inches to about 0.2 inches, about 0.2 inches to about 0.3 inches, about 0.3 inches to about 0.4 inches, or about 0.4 inches to about 0.5 inches. In other embodiments, the maximum thickness T₂ may be larger or smaller.

As mentioned above, the superhard table 412 may aid in dissipating heat from the thrust bearing assembly 100 (see in FIG. 1A). In an embodiment, the bearing surface 418 of the superhard may be exposed to a fluid (e.g., drilling or cooling fluid). Accordingly, the heat may be transferred from the superhard table 412 to the fluid, thus dissipating the heat from the superhard bearing element 410 and the thrust-bearing assembly 100.

In addition, the side portions or region 436 of the superhard bearing table 412 may increase the surface area of the superhard table 412 that is in thermal communication with the fluid and/or the support ring 102 (see FIG. 4C). Thus, more heat may be dissipated from the superhard table 412 as the fluid contacts the region 436 of the superhard table 412. Consequently, the thermally-conductive superhard table 412 may better dissipate an overall thermal load on the thrust bearing assembly 100 as well as on the superhard bearing element 410. As such, useful life and/or operating conditions of the thrust bearing assembly 100 (see FIG. 1A) may be increased.

Optionally, at least a portion of the superhard table 412 can be in thermal communication with the support ring as shown in FIG. 4C. Thus, heat from one or more of the superhard bearing elements 410 may be transferred from the superhard table 412 to the support ring 102, and/or to other superhard bearing elements 410. In an embodiment, a portion of the superhard table 412 may extend below a top surface 121 of the support ring 102. Optionally, a portion of the superhard table 412 may be in contact with the support ring 102. In an embodiment, the support ring 102 may include one or more copper materials and heat may be transferred from one or more portions of the superhard table 412, through the support ring 102, and then to the fluid and/or the environment during operation of the thrust-bearing assembly 100. In other embodiments, the support ring 102 may include one or more thermally-conductive structures and heat may be transferred from one or more portions of the superhard table 412, through the support ring 102 and/or the thermally-conductive structure, and then to the fluid and/or the environment during operation of the thrust-bearing assembly. Examples of different thermally-conductive structures are disclosed in U.S. patent application Ser. No. 13/801,125, the disclosure of which is incorporated herein, in its entirety, by this reference.

In another embodiment, as shown in FIGS. 4D and 4E, the interfacial surface 416A of the substrate 414 may include a recessed region 429 and a surface 431. The recessed region 429 may extend a distance “d” below the surface 431. For example, the distance “d” may be about 0.001 inches to about 0.40 inches, about 0.03 inches to about 0.30 inches, about 0.05 inches to about 0.25 inches, or about 0.08 inches to about 0.20 inches. In an embodiment, the distance “d” may be about 0.1 inches to about 0.2 inches, about 0.2 inches to about 0.3 inches, or about 0.3 inches to about 0.4 inches. In the illustrated embodiment, the recessed region 429 is a cavity exhibiting a generally rectangular cross-sectional geometry. However, the recessed region 429 may exhibit other selected geometries, such as the cavity having an ovoid geometry, a semi-elliptical geometry, a truncated geometry, a non-truncated geometry, or another suitable geometry. While one recessed region 429 is illustrated, in other embodiments, the superhard table 412 may include one, three, four, or any other suitable number of recessed regions 429. For example, in an embodiment, the superhard table 412 may include a first recessed region on a leading edge of the superhard bearing element 410 and a second recessed region on a trailing edge of the superhard bearing element 410. The first and second recessed regions may be similarly configured. In other embodiments, the first and second recessed regions may be configured differently. For example, in an embodiment, one of the recessed regions may be larger than the other recessed region.

In an embodiment, the superhard table 412 may exhibit a non-uniform thickness over the interfacial surface 416A and may include an interfacial surface 440A that may be configured to correspond to the topography of the interfacial surface 416A of the substrate 414. For example, a protrusion 442 of the superhard table 412 may fill the recessed region 429 in the interfacial surface 416A. A maximum thickness T₂ of the superhard table 412 may be located in the protrusion 442 of the superhard table 412 immediately over the recessed region 429 as measured from the bearing surface 418. For example, at least one portion of the superhard table 412 may exhibit an L-like cross-sectional geometric shape. In an embodiment, the maximum thickness T₂ may be between 0.125 inches and about 0.2 inches, about 0.2 inches and about 0.3 inches, about 0.3 inches and about 0.4 inches, or about 0.4 inches and about 0.5 inches. In other embodiments, the maximum thickness T₂ may be larger or smaller.

Consequently, the superhard table 412 may be thicker within protrusion 442. Such a configuration may increase the amount of surface of the superhard table 412 that is in thermal communication with the fluid and/or the support ring 102 (see, e.g., FIG. 4C). In addition, heat may be dissipated from the superhard table 412 as the fluid contacts the protrusion 442 of the superhard bearing element 410. Accordingly, the protrusion 442 may help reduce overall thermal load on the thrust-bearing assembly 100 (see, e.g., FIG. 1A) as well as on the superhard bearing element(s) 410 thereof. As such, useful life and/or operating conditions of the thrust-bearing assembly 100 may be increased.

In an embodiment, when the superhard bearing elements 410 are attached to the support ring 102 (shown in FIG. 1B), the protrusions 442 of the superhard bearing elements 410 may be substantially aligned in reference to the degradation path 111. Consequently, the superhard table 412 may be thicker within the degradation path. Such a configuration may increase the amount of surface of the superhard table 412 that may be in thermal communication with the fluid and/or the support ring 102 within the degradation path 111. Thus, reducing the temperature of hot spots may increase an overall heat dissipation from the superhard bearing elements 410 within the degradation path 111.

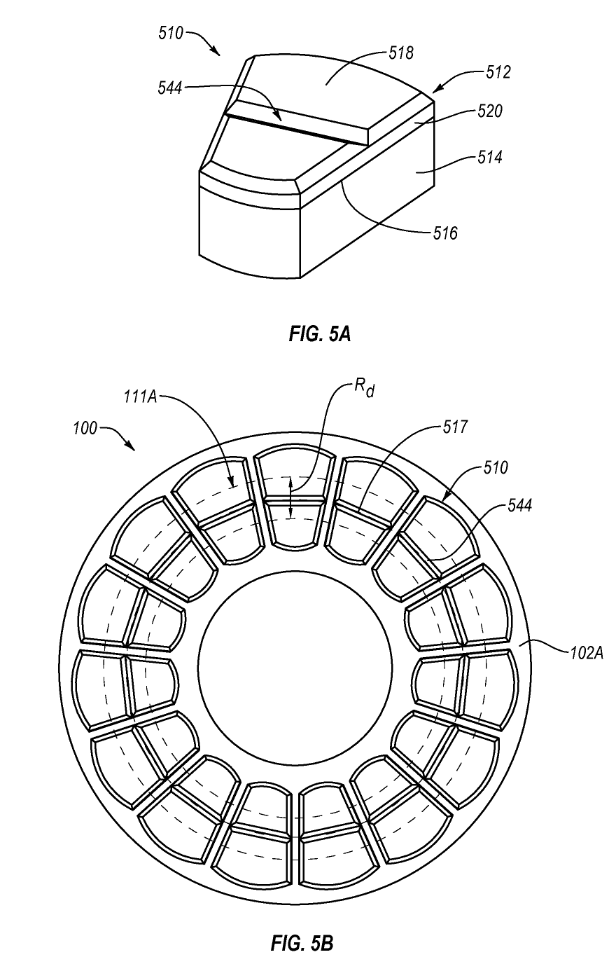

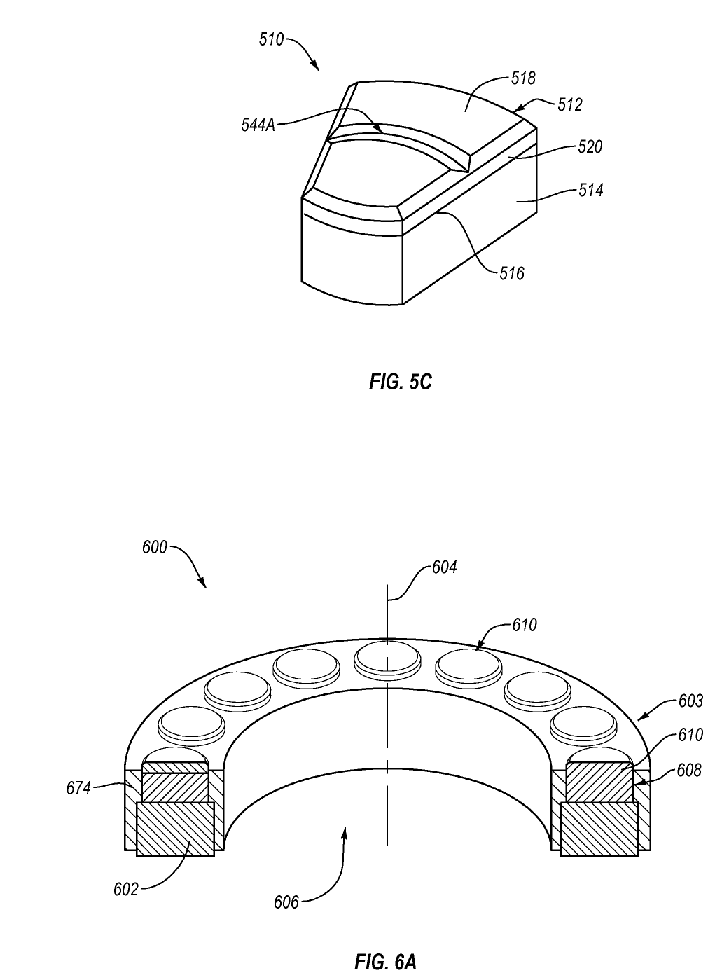

FIG. 5A is an isometric view of a superhard bearing element 510 including a superhard table having one or more grooves formed therein according to another embodiment. It should be noted that the embodiments of the superhard bearing element 510 may be employed with any of the embodiments and/or features described with respect to FIGS. 1A through 4E.

The superhard bearing element 510 includes a superhard table 512 and a substrate 514 having an interfacial surface 516 that is bonded to the superhard table 512. The superhard table 512 may define a bearing surface 518 and a peripheral surface 520. The substrate 514 may be formed from the same materials as described herein with respect to substrates 114, 214, and 314. For example, in an embodiment, the substrate 514 may comprise a cemented carbide substrate, such as a cobalt-cemented tungsten carbide substrate. In other embodiments, the substrate 514 may include a PCD core portion surrounded by tungsten carbide and/or copper. The superhard table 512 may be formed from the same materials as the superhard table 112. For example, in an embodiment, the superhard table 512 may comprise polycrystalline diamond. In the illustrated embodiment, the superhard bearing element 510 may have a wedge-like shape. In other embodiments, however, the superhard bearing element 510 may have a generally rounded rectangular shape, a generally cylindrical shape, a generally oval shape, combinations thereof, or any other suitable shape.

As shown in FIG. 5A, the superhard bearing element 510 may include a groove 544 formed in the superhard table 512. In an embodiment, the groove 544 may have a generally V-shaped cross-sectional shape and may extend along a generally linear or arcuate path in the bearing surface 518 between opposite lateral surfaces 545 of the superhard table 512. In an embodiment, the groove 544 may have a depth that extends between a bottom portion of the groove 544 and the bearing surface 518. For example, the bottom portion of the groove 544 may be positioned within the superhard table 512. In other embodiments, the bottom portion of the groove 544 may be positioned within the substrate 514. In yet other embodiments, the depth of the groove 544 may be about 0.01 inches to about 0.050 inches, about 0.050 inches to about 0.10 inches, about 0.1 inches to about 0.2 inches, about 0.2 inches to about 0.3 inches, about 0.3 inches to about 0.4 inches, or about 0.4 inches to about 0.5 inches. In other embodiments, the depth of the groove 544 may be greater than about 0.010 inches, greater than about 0.05 inches, greater than about 0.1 inches, greater than about 0.3 inches, or greater than about 0.4 inches. In other embodiments, the depth of the groove 544 may be deeper or shallower. In an embodiment, the depth of the groove 544 may vary along its path. For example, in an embodiment, the groove 544 may have a depth that includes a deeper portion and a shallower portion. As fluid flows about the superhard bearing element(s) 510, the fluid may remove heat from the superhard bearing element(s) 510, thereby cooling the superhard bearing elements 510. The groove 544 formed in the superhard table 512 may increase the surface area of the superhard table 512 exposed to the fluid. Accordingly, the groove 544 may increase the rate of heat transfer between the superhard bearing elements 510 and the fluid (e.g., through convection). In addition, the groove 544 may help pump the fluid onto the bearing surface 518 by directing the fluid onto the bearing surface 518 as the fluid flows about the superhard bearing element 510. Thus, the groove 544 may help reduce the overall thermal load on the thrust-bearing assembly 100 as well as on the superhard bearing element(s) 510 thereof. As such, useful life and/or operating conditions of the thrust-bearing assembly 100 may be increased.

In an embodiment, the grooves 544 of the superhard bearing elements 510 may be positioned a radial distance R_{d} from a radial center 517 of the superhard bearing elements 510. For example, in an embodiment, one or more of the grooves 544 may be positioned a radial distance R_{d} less than about plus or minus 0.050 inches, about plus or minus 0.10 inches, about plus or minus 0.20 inches, about plus or minus 0.25 inches, about plus or minus 0.30 inches, or about plus or minus 0.40 inches from the radial center 517 of the superhard bearing elements 510. In yet other embodiments, one or more of the grooves 544 may be positioned a radial distance R_{d} between about plus or minus 0 inches and about 0.10 inches, about plus or minus 0.10 inches and about 0.20 inches, about plus or minus 0.20 inches and about plus or minus 0.25 inches, about plus or minus 0.25 inches and about plus or minus 0.30 inches, about plus or minus 0.30 inches and about plus or minus 0.40 inches from the radial center 517 of the superhard bearing elements 510. In other embodiments, one or more of the grooves 544 may be positioned a larger or smaller radial distance R_{d} from the radial center 517 of the superhard bearing elements 510.

In an embodiment, the radial distance R_{d} the grooves 544 are positioned from the radial center 517 of the superhard bearing elements 510 may be configured to generally position the grooves 544 within a degradation path. For example, as discussed above, hot spots on the superhard tables 512 can result in thermal damage that progresses from one superhard bearing element 510 to another along a degradation path 111A (shown in FIG. 5B). In an embodiment, the grooves 544 of the superhard tables 512 may be substantially aligned to or within to the degradation path 111A when the superhard bearing elements 510 are attached to the support ring 102A. Consequently, the amount of surface of the superhard table 512 that is in thermal contact with the fluid in the degradation path 111A may be increased. Thus, reducing the temperature of such hot spots by increasing overall heat dissipation from the superhard bearing elements 510 within the degradation path 111 reduces the risk of thermal damage to the superhard bearing elements 510.

While only one groove 544 is illustrated, in other embodiment, the superhard table 512 may include two, three, or any other suitable number of grooves. Moreover, while the groove 544 is illustrated in the bearing surface 518 of the superhard table 512, in other embodiments, the groove 544 may be formed in the lateral surface 520 of the superhard table 512. Further, while the groove 544 is shown exhibiting a V-like cross-sectional shape, in other embodiments, the groove 544 may include a generally parabolic cross-section, a generally U-shaped cross-section, a generally elliptical cross-section, a generally trapezoidal cross-section, combinations thereof or the like. In addition, while the groove 544 is illustrated extending along a generally linear path, in other embodiments, the groove 544 may be curved, irregularly shaped, L-shaped, discontinuous, change directions, have a varying depth, combinations thereof, or any other suitable shape. In other embodiments, the groove 544 may exhibit any suitable size and/or configuration, including, but not limited, to the grooves disclosed in U.S. patent application Ser. No. 13/306,332, the disclosure of which is incorporated herein, in its entirety, by this reference. By varying the cross-sectional shape, length, and/or path of the groove 544, the amount of surface of the superhard table 512 that can be in thermal communication with the fluid may be varied. For example, as shown in FIG. 5C, the groove 544A may be configured as an arcuate or curved groove on the bearing surface 518 of the superhard table 512. By forming an arcuate or curved groove, the length of the groove 544A extending between the opposite lateral edges of the groove 544A may be increased, thereby increasing the amount of the superhard table 512 that can be in thermal communication with the fluid.

While the groove(s) are illustrated extending the entire distance between the lateral edges of the superhard table 512, in other embodiments, the grooves 544 may extend only a portion of the distance between the lateral edges of the superhard table 512. For example, in an embodiment, the groove 544 may extend only a portion of the distance from one or more of the lateral edges of the superhard table 512. For example, in an embodiment, the groove 544 may be configured to extend a selected distance from a leading or trailing lateral edge of the superhard table 512 to help efficiently cool hot spots formed in the degradation path 111 or other portions of the superhard table 512.

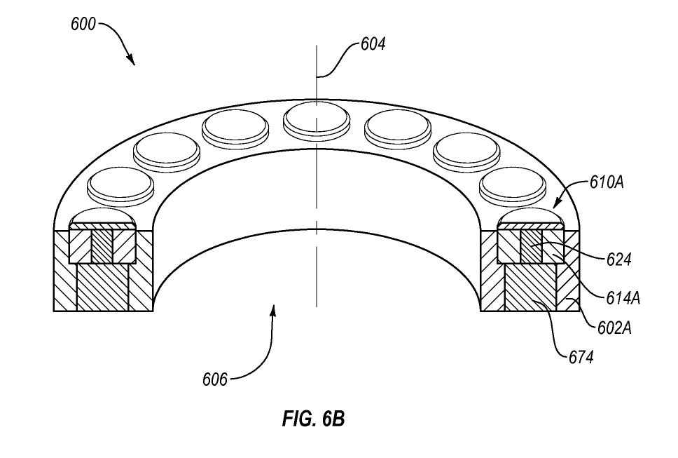

FIG. 6A is a partial isometric cutaway view of a thrust-bearing assembly 600 according to another embodiment. It should be noted that the embodiments of the thrust-bearing assembly 600 may be employed with any of the embodiments and/or features described with respect to FIGS. 1A through 5C.

The thrust-bearing assembly 600 may include a support ring assembly 603 extending circumferentially about a central axis 604. The thrust-bearing 600 further may include a plurality of superhard bearing elements 610. In an embodiment, at least some of the superhard bearing elements 610 may comprise a PCD slug, which may be optionally partially or substantially fully leached, coupled to and/or supported by the support ring assembly 603. In other embodiments, at least some of the superhard bearing elements 610 may comprise a superhard table bonded to a substrate comprising high-grade tungsten carbide. In yet other embodiment, at least some of the superhard bearing elements 610 may comprise a superhard table bonded to a substrate including one or more discrete portions comprising one or more thermally-conductive materials. For example, at least some of the superhard bearing elements 610 may comprise a superhard table bonded to a substrate including a PCD core portion. In an embodiment, the support ring assembly 603 may include a plurality of recesses 608 within which the superhard bearing elements 610 may be secured.

In an embodiment, the support ring assembly 603 may include a support ring 602 that supports the superhard bearing elements 610. Furthermore, the support ring assembly 603 may be at least partially surrounded by or encased in a thermally-conductive element 674. The thermally-conductive element 674 may be a substantially uniform or unitary piece, which at least partially encases or encapsulates the support ring 602. For example, the thermally-conductive element 674 may define an outer perimeter of the thrust-bearing assembly 600. Optionally, the thermally-conductive element 674 may define an opening 606 of the thrust-bearing assembly 600. In an embodiment, the recesses 608 may be formed in the thermally-conductive element 674 member and the superhard bearing elements 610 may be secured therein in any suitable manner. For example, the superhard bearing elements 610 may be press-fitted into the recesses 608 and/or brazed to the thermally-conductive element 674. In other embodiments, the recesses 608 may be countersunk through holes and the superhard bearing elements 610 may include a shoulder or other geometric feature that helps retain the superhard bearing elements 610 in cooperation with the thermally-conductive element 674. Examples of other suitable combinations of superhard bearing elements, support rings, and thermally-conductive elements that may be used in combination with any of the embodiments disclosed herein are disclosed in U.S. patent application Ser. No. 13/801,125.

The thermally-conductive element 674 may include any number of suitable thermally-conductive materials including, but not limited to, copper, copper alloys, aluminum and aluminum alloys, combinations thereof, or any other suitable material. In an embodiment, the thermally-conductive element 674 may provide thermal communication between the support ring 602 and the superhard bearing elements 610. For example, the thermally-conductive element 674 may be sized and configured to thermally and physically contact the support ring 602 and the superhard bearing elements 610. Accordingly, heat may be transferred from the superhard bearing elements 610 to the support ring 602 via the thermally-conductive element 674.

In an embodiment, the thermally-conductive element 674 may provide a thermal connection between one or more of the superhard bearing elements 610. Thus, the thermally-conductive element 674 may at least partially redistribute the thermal load from one or more of the superhard bearing elements 610. Additionally, redistributing the thermal loads between the superhard bearing elements 610 may help share or substantially equalize thermal loads on the superhard bearing elements 610. In other words, such redistribution may produce substantially the same or similar temperature across at least some of the superhard bearing elements 610. As such, the collective heat capacity of selected bearing elements may be utilized to absorb heat produced during the operation of the bearing assembly 600. In yet other embodiments, the thermally-conductive element 674 may be configured to help dissipate heat from the superhard bearing elements 610 by increasing convective heat transfer between the superhard bearing elements 610 and the cooling fluid.

The support ring 602 may be formed of the same materials as the support ring 102. Moreover, in an embodiment, the support ring 602 may comprise a material that exhibits a higher strength than the thermally-conductive material comprising the sleeve member 674. Accordingly, the support ring 602 may provide greater support to the superhard bearing elements 610. In at least one embodiment, a bottom surface of the support ring 602 may be coplanar with or protrude past a bottom surface of the sleeve member 674. As such, the support ring 602 can be configured to carry at least some of the load experienced by the superhard bearing elements 610.

In an embodiment, the support ring 602 may be press-fitted into an opening or a channel in the sleeve member 674. In other embodiments, the support ring 602 may be brazed, press-fitted, welded, fastened, press-fit, combinations of the foregoing, or otherwise secured to the sleeve member 674.

As shown, the superhard bearing elements 610 may reside directly on the support ring 602. In an embodiment, the superhard bearing elements 610 may be secured to the support ring 602. For example, the superhard bearing elements 610 may be brazed or otherwise secured to the support ring 602. Optionally, the support ring 602 may include recesses that can receive and/or help restrain the superhard bearing elements 610 therein. Such recesses may at least partially restrain the superhard bearing elements 610 from moving relative to the support ring 602.

As described above, the thermally-conductive element 674 may provide thermal communication among and between the superhard bearing elements 610 of the thrust-bearing assembly 600. Accordingly, the thermally-conductive element 674 may help distribute the thermal load from one or more of the superhard bearing elements 610 among all or substantially all of the superhard bearing elements 610.

In some embodiments, at least a portion of the superhard bearing element 610 may be in thermal communication with the thermally-conductive element 674. Thus, heat from one or more of the superhard bearing elements 610 may be transferred from the superhard bearing elements 610 to the thermally-conductive element 674, and/or to other superhard bearing elements 610. For example, in the embodiment shown in FIG. 6B, a core portion 624 of the substrate of the superhard bearing element 610A may thermally connect the superhard bearing element 610A to the thermally-conductive element 674. Moreover, as fluid flows about the thermally-conductive element 674, the fluid may remove heat from the thermally-conductive element 674 and the superhard bearing elements 610. In other embodiments, heat may be transferred from the superhard bearing elements 610 to the thermally-conductive structure 674 and/or the fluid.

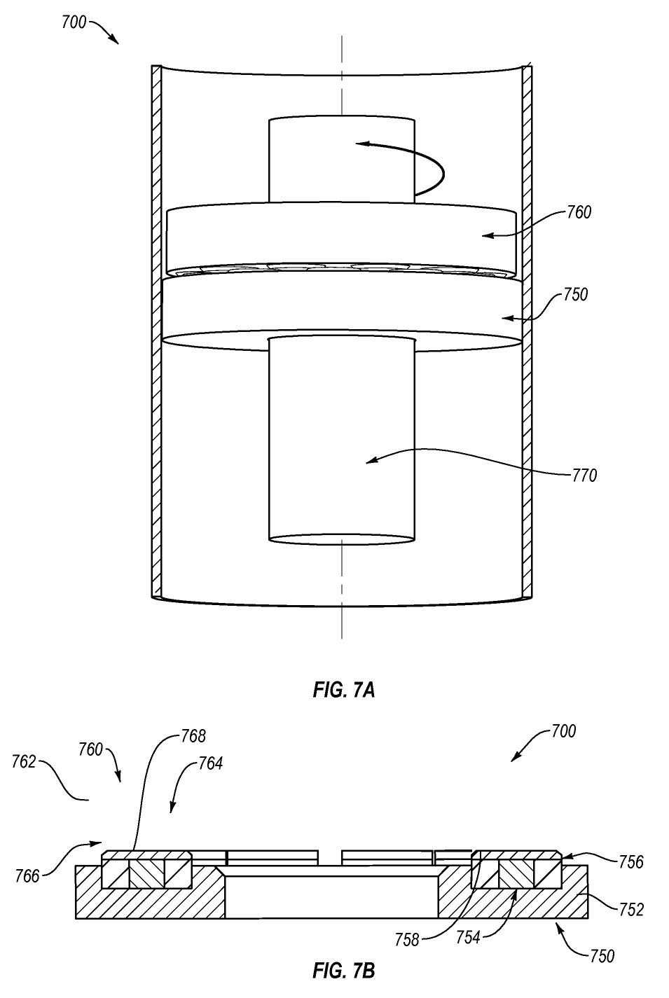

Any of the above-described thrust-bearing assembly embodiments may be employed in a thrust-bearing apparatus. FIG. 7A is an isometric view of thrust-bearing apparatus 700. The thrust bearing apparatus 700 may include a stator 750 configured as any of the previously described embodiments of thrust-bearing assemblies. For example, the stator 750 may include a support ring 752. The support ring 752 may be formed from the same materials as the support ring 102 and may include a plurality of recesses 754 formed therein. The stator 750 further may include a plurality of superhard bearing elements 756, each partially disposed and mounted in a corresponding one of the recesses 754 of the support ring 752. The superhard bearing elements 756 may include a bearing surface 758 and at least some of the superhard bearing element 756 may exhibit, for example, the configuration of the superhard bearing elements 210.

The thrust-bearing apparatus further may include a rotor 760. The rotor 760 may include a support ring 762 including a plurality of recesses 764 formed therein. The rotor 760 further may include a plurality of superhard bearing elements 766, each partially disposed and mounted in a corresponding one of the recesses 764 of the support ring 762. The superhard bearing elements 766 may include a bearing surface 768 and at least some of the superhard bearing elements 766 may exhibit, for example, the configuration of the superhard bearing elements 110.

As shown, a shaft 770 may be coupled to the support ring 762 and operably coupled to an apparatus capable of rotating the shaft 770 in a direction R (or in a generally opposite direction), such as a downhole motor. For example, the shaft 770 may extend through and may be secured to the support ring 762 of the rotor 760 by press-fitting or threadedly coupling the shaft 770 to the support ring 762 or another suitable technique. A housing 772 may be secured to the support ring 752 of the stator 750 and may extend circumferentially about the shaft 770 and the rotor 860.

FIG. 7B is a cross-sectional view in which the shaft 870 and housing 772 are not shown for clarity. In operation, lubricating/cooling fluid, or mud may be pumped between the shaft 770 and the housing 772, and between the superhard bearing elements 756 of the stator 750. In an embodiment, the stator 750 and/or the rotor 760 may include one or more thermal management features. The one or more thermal management features may be configured to effectively provide heat dissipation and/or heat distribution for superhard bearing elements and/or the support rings. For example, in an embodiment, the superhard bearing elements 756 may include thermally-conductive core portions. The core portions may provide thermal communication between the support ring 752 and the bearing surface 758. Accordingly, heat may be transferred from the bearing surface 758 to the support ring 752 via the core portions. In other embodiments, the stator 750 and/or the rotor 760 may include one or more thermally-conductive elements that provide thermal communication between the respective support rings and superhard bearing elements.

Under certain operational conditions, the thrust-bearing apparatus 700 may be operated as a hydrodynamic bearing. For example, where the rotational speed of the rotor 760 is sufficiently great and the thrust load is sufficiently low, a fluid film may develop between the bearing surfaces 758 of the stator 750 and the bearing surfaces 768 of the rotor 760. The fluid film may have sufficient pressure to reduce or prevent contact between the respective bearing surfaces 758, 768 and thus, substantially reduce wear of the superhard bearing elements 756 and/or the superhard bearing elements 766. In such a situation, the thrust-bearing apparatus 700 may be described as operating hydrodynamically. Thus, the thrust-bearing apparatus 700 may be operated to improve lubrication, cooling, bearing capacity, and/or as a hydrodynamic bearing.

In some instances, the bearing apparatus 700 may receive and/or generate more heat in or near a first portion thereof (e.g., a portion closer to shaft 770), which may increase the temperature in the first portion of the thrust-bearing apparatus 700, while the temperature in a second portion of the thrust-bearing apparatus 700 may remain at a lower temperature. Such uneven temperature distribution may warp the thrust-bearing apparatus 700. Warping may inhibit or prevent hydrodynamic operation of the thrust-bearing apparatus 700. In an embodiment, the thermal management features (e.g., thermally-conductive core portions, thermally-conductive outer portions, grooves, etc.) may help reduce or eliminate uneven temperature distribution within the superhard bearing elements 756, 766 and/or components of the thrust-bearing apparatus 700. Consequently, the thermal management features of the thrust-bearing apparatus 700 may reduce thermal warping of the thrust-bearing apparatus 700, which may increase the useful life thereof.

The concepts used in the thrust-bearing assemblies and apparatuses described above may also be employed in radial, angular contact, roller, combinations thereof, or any other suitable bearing assemblies and apparatuses.

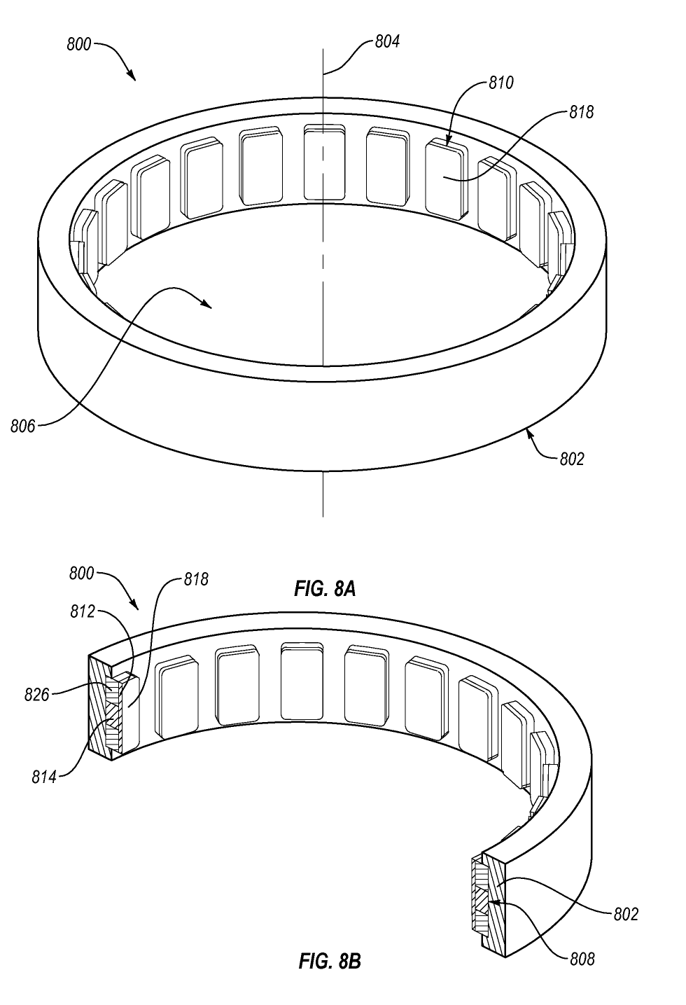

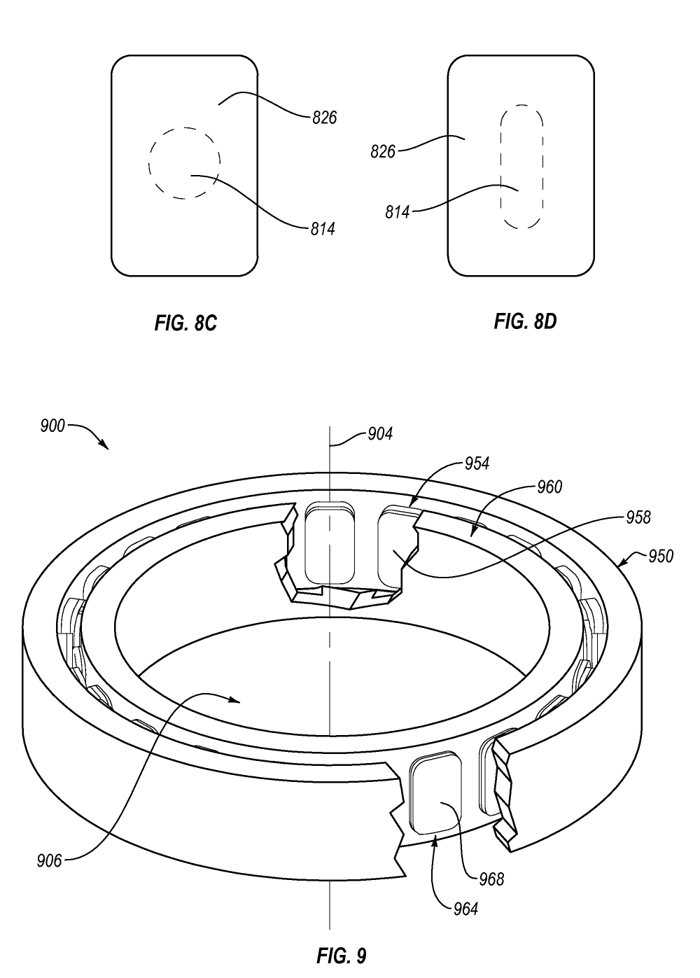

FIGS. 8A and 8B are isometric and isometric cutaway views, respectively, illustrating a radial bearing assembly 800 according to an embodiment. The radial bearing assembly 800 may include a support ring 802 extending about a rotation axis 804. The support ring 802 may include an inner peripheral surface defining a central opening 806. The inner peripheral surface of the support ring 802 may include a plurality of recesses 808 formed therein. The support ring 802 may also include an outer peripheral surface. A plurality of superhard bearing elements 810 may be distributed circumferentially about the rotation axis 804. Each of the superhard bearing elements 810 may be partially disposed in a corresponding one of the recesses 808 of the support ring 802 and secured partially therein via brazing, press-fitting, threadedly attaching, fastening with a fastener, combinations of the foregoing, or another suitable technique. As shown, the superhard bearing elements 810 may be distributed circumferentially about the rotation axis 804 in a single row. In other embodiments, the superhard bearing elements 810 may be circumferentially distributed in two rows, three rows, four rows, or any other number of rows.

At least some of the superhard bearing elements 810 may comprise a superhard table 812 and a substrate 814 having an interfacial surface that is bonded to the superhard table 812. The superhard table 812 may define a concavely-curved bearing surface 818 (e.g., curved to lie on an imaginary cylindrical surface) and a peripheral surface. The superhard bearing elements 810 may have a generally rounded rectangular shape and each made from any of the materials discussed above relative to the superhard bearing elements 110, 210, 310, and 410. In other embodiments, the superhard bearing elements 810 may have a cylindrical shape, non-cylindrical shape, a generally wedge-like shape, an elliptical shape, or any other suitable shape.

In an embodiment, at least some of the superhard bearing elements 810 may include one or more thermal management features. For example, in an embodiment, one or more of the superhard bearing elements 810 may be configured similar to superhard bearing elements 110, 210, 310, 410, or 510. In an embodiment, the superhard bearing elements 810 may include a thermally-conductive annular, outer portion 826 positioned on the substrate 814 (see also FIGS. 8C and 8D). The outer portions 826 may provide thermal communication between the support ring 802 and the superhard bearing table 812. Accordingly, heat may be transferred from the superhard table 812 to the support ring 802 via the outer portion 826. Moreover, as fluid flows about the outer portion 826, the fluid may remove heat from the superhard bearing elements 810, thereby cooling the superhard bearing elements 810. Thus, the thermally-conductive outer portion 826 may increase the rate of heat transfer between the superhard bearing elements 810 and the fluid (e.g., through convection).

FIG. 9 is an isometric cutaway view of a radial bearing apparatus 900 according to an embodiment. The radial bearing apparatus 900 may include an inner race 960 (i.e., a rotor). The inner race 960 may define an opening 906 and may include a plurality of circumferentially-adjacent superhard bearing elements 964 distributed about a rotation axis 904, each of which includes a convexly-curved bearing surface 968. The radial bearing apparatus 900 may further include an outer race 950 (i.e., a stator) that extends about and receives the inner race 960. The outer race 950 may include a plurality of circumferentially-adjacent superhard bearing elements 954 distributed about the rotation axis 904, each of which includes a concavely-curved bearing surface 958 curved to correspond to the convexly-curved bearing surfaces 968. The superhard bearing elements 954 and 964 may have a generally rounded rectangular shape and each may be made from any of the materials discussed above relative to the superhard bearing elements 110. In other embodiments, the superhard bearing elements 954 and 964 may have a generally wedge-like shape, a generally cylindrical shape, a non-cylindrical shape, generally elliptical shape, or any other suitable shape. The terms “rotor” and “stator” refer to rotating and stationary components of the radial bearing apparatus 900, respectively. Thus, if the outer race 950 is configured to remain stationary, the outer race 950 may be referred to as the stator and the inner race 960 may be referred to as the rotor.

At least some of the superhard bearing elements 954 and/or the superhard bearing elements 964 may include one or more thermal management features configured to promote efficient heat transfer from one or more portions of the superhard bearing elements 954, 964. The one or more of the thermal management features (e.g., non-uniform superhard table thickness) may be configured to influence lubrication, cooling, and/or bearing capacity of the superhard bearing elements 954, 964 and/or the inner race 960 and/or the outer race 950. Moreover, under certain operating conditions the thermal management features may help form a fluid film similar to the description in relation to FIGS. 7A and 7B. A shaft or spindle (not shown) may extend through the opening 906 and may be secured to the rotor 960 by press-fitting the shaft or spindle to the rotor 960, threadedly coupling the shaft or spindle to the rotor 960, or another suitable technique. A housing (not shown) may also be secured to the stator 950 using similar techniques.

The radial bearing apparatus 900 may be employed in a variety of mechanical applications. For example, so-called “rotary cone” rotary drill bits, pumps, transmissions or turbines may benefit from a radial bearing apparatus discussed herein.

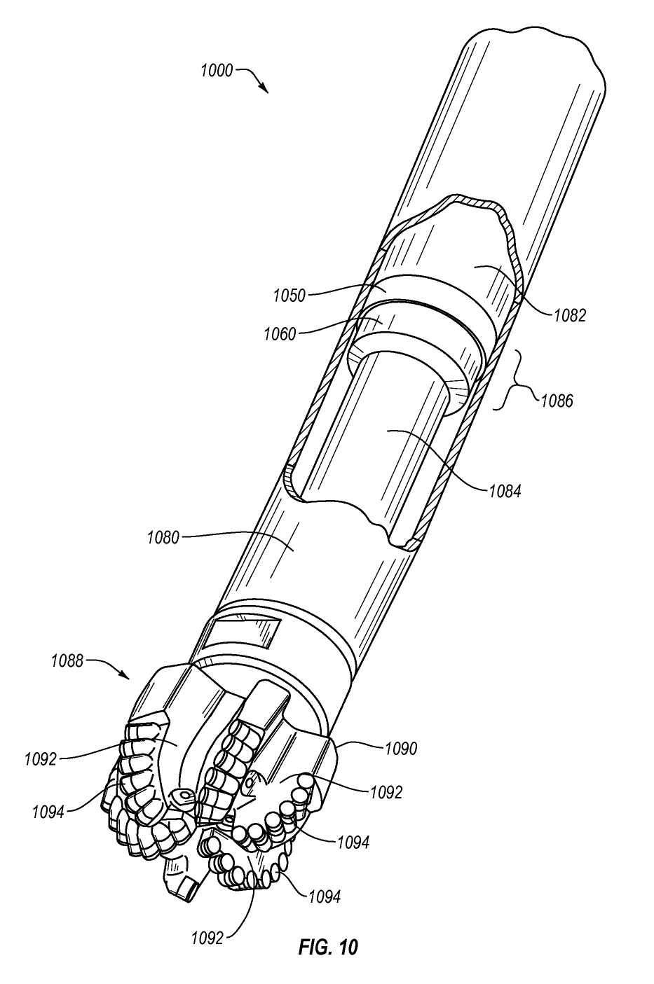

Any of the embodiments for superhard bearing elements, bearing assemblies, and apparatuses discussed above may be used in a subterranean drilling system. FIG. 10 is a schematic isometric cutaway view of a subterranean drilling system 1000 according to an embodiment. The subterranean drilling system 1000 may include a housing 1080 enclosing a downhole drilling motor 1082 (i.e., a motor, turbine, or any other device capable of rotating an output shaft) that may be operably connected to an output shaft 1084. A thrust-bearing apparatus 1086 may be operably coupled to the downhole drilling motor 1082. The thrust bearing apparatus 1086 may be configured as any of the previously described bearing apparatus embodiments. A rotary drill bit 1088 may be configured to engage a subterranean formation and drill a borehole and may be connected to the output shaft 1084. The rotary drill bit 1088 is shown comprising a bit body 1090 that includes radially and longitudinally extending blades 1092 with a plurality of polycrystalline diamond cutting elements 1094 secured to the blades 1092. However, other embodiments may utilize different types of rotary drill bits, such as core bits and/or roller-cone bits. As the borehole is drilled, pipe sections may be connected to the subterranean drilling system 1000 to form a drill string capable of progressively drilling the borehole to a greater depth within the earth.

The thrust-bearing apparatus 1086 may include a stator 1050 that does not rotate and a rotor 1060 that may be attached to the output shaft 1084 and rotates with the output shaft 1084. As discussed above, the thrust-bearing apparatus 1086 may be configured as any of the embodiments disclosed herein. For example, the stator 1050 and/or the rotor 1060 may include one or more thermal management features configured to promote efficient heat transfer from one or more portions of the stator 1050 and/or the rotor 1060.

Although the bearing assemblies and apparatuses described above have been discussed in the context of subterranean drilling systems and applications, in other embodiments, the bearing assemblies and apparatuses disclosed herein are not limited to such use and may be used for many different applications, if desired, without limitation. Thus, such bearing assemblies and apparatuses are not limited for use with subterranean drilling systems and may be used with various mechanical systems, without limitation.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A bearing assembly, comprising:
a support ring extending circumferentially about a central axis;
a plurality of superhard bearing elements distributed circumferentially about the central axis, each of the plurality of superhard bearing elements being mounted to the support ring and including a superhard table having bearing surface; and
one or more thermal management features including at least one of one or more thermally conductive structures or at least one of the superhard tables of the plurality of superhard bearing elements exhibiting a non-uniform thickness structured to promote cooling thereof during use.

2. The bearing assembly of claim 1, wherein the superhard table of at least one of the plurality of superhard bearing elements includes a polycrystalline diamond table, and wherein the at least one of the plurality of superhard bearing elements includes the polycrystalline diamond table bonded to a substrate.

3. The bearing assembly of claim 2, wherein the polycrystalline diamond table exhibits a non-uniform thickness, wherein the polycrystalline diamond table includes a center region and an outer region surrounding the center region, and wherein one or more portions of the outer region surround at least a portion of a lateral surface the substrate.

4. The bearing assembly of claim 3, wherein the one or more portions of outer region contacts the support ring.

5. The bearing assembly of claim 3, wherein the polycrystalline diamond table exhibits a U-like cross-sectional geometric shape.

6. The bearing assembly of claim 3, wherein a portion of the polycrystalline diamond table exhibits an L-like cross-sectional geometric shape.

7. The bearing assembly of claim 3, wherein the substrate includes an interfacial surface having a raised portion and the center region of the polycrystalline diamond table exhibits a minimum thickness over the raised portion.

8. The bearing assembly of claim 2, wherein the one or more thermally conductive structures includes one or more core portions positioned within the substrate, wherein the one or more core portions exhibit a higher thermal-conductivity than the substrate.

9. The bearing assembly of claim 8, wherein the one or more core portions physically and thermally contacts the support ring and the polycrystalline diamond table.

10. The bearing assembly of claim 8, wherein the one or more core portions includes at least one of polycrystalline diamond, a copper material, or an aluminum material.

11. The bearing assembly of claim 2, wherein the one or more thermally conductive structures includes a thermally-conductive outer portion positioned to surround at least a portion of the substrate, the outer portion exhibiting a higher thermal-conductivity than at least a portion of the substrate.

12. The bearing assembly of claim 11, wherein the outer portion physically and thermally contacts the polycrystalline diamond table and the support ring.

13. The bearing assembly of claim 11, wherein the outer portion includes one or more copper materials.

14. The bearing assembly of claim 1, wherein the one or more thermally conductive structures includes a thermally-conductive element that at least partially encloses the support ring and interconnects the plurality of superhard bearing elements.

15. The bearing assembly of claim 14, wherein the thermally-conductive element includes one or more copper materials.

16. The bearing assembly of claim 14, wherein at least one of the plurality of superhard tables includes a polycrystalline diamond body.

17. The bearing assembly of claim 14, wherein the thermally-conductive element thermally and physically contacts the support ring and the plurality of superhard bearing elements.

18. The bearing assembly of claim 2, wherein the one or more thermally conductive structures includes the substrate including a high-grade tungsten carbide exhibiting a thermal conductivity greater than about 80 W/m*K.

19. The bearing assembly of claim 1, wherein each of the bearing surfaces includes a concavely-curved bearing surface or convexly-curved bearing surface.

20. The bearing assembly of claim 2, wherein the polycrystalline diamond table exhibits a non-uniform thickness and includes one or more grooves formed therein, the one or more grooves being positioned and configured to reduce one or more hot spots on the bearing surface thereof within a degradation path around the support ring.

21. A bearing apparatus, comprising:
a first bearing assembly including:
a first support ring extending circumferentially about a central axis;
a first plurality of superhard bearing elements distributed circumferentially about the central axis, each of the first plurality of superhard bearing elements being mounted to the first support ring and including a superhard table having a bearing surface; and
one or more thermal management features including at least one of one or more thermally conductive structures or at least one of the superhard tables of the plurality of superhard bearing elements exhibiting a non-uniform thickness structured to promote cooling thereof during use, the one or more thermal management features being in thermal communication with at least one of the first support ring or one or more of the bearing surfaces of the plurality of superhard and being configured to promote heat transfer away from the one or more of the bearing surfaces; and
a second bearing assembly including:
a second support ring extending circumferentially about the central axis;
a second plurality of superhard bearing elements generally opposed the first plurality of superhard bearing elements of the first bearing assembly, each of the second plurality of superhard bearing elements being attached to the second support ring.

22. The bearing apparatus of claim 21, wherein the first bearing assembly is configured as a rotor, and the second bearing assembly is configured as a stator.

23. The bearing apparatus of claim 21, wherein the one or more thermally conductive structures include at least one thermally-conductive core portion attached to each of the first plurality of superhard bearing elements.

24. A method for manufacturing a superhard bearing element, the method comprising:
removing a portion of a substrate;
replacing the removed portion of the substrate with a thermally-conductive element that is more thermally conductive than the substrate; and
attaching a superhard table to an interfacial surface of the substrate to form the superhard bearing element.

25. The method of claim 24, wherein the removed portion of the substrate is replaced with the thermally-conductive element before the superhard table is attached to the interfacial surface of the substrate.

26. The method of claim 24, wherein the removed portion of the substrate is replaced with the thermally-conductive element after the superhard table is attached to the interfacial surface of the substrate.

27. The method of claim 24, wherein the removed portion of the substrate is replaced with the thermally-conductive element simultaneously with the superhard table being attached to the interfacial surface of the substrate.

28. The method of claim 24, wherein the thermally-conductive element includes a core portion within the substrate and includes at least one of polycrystalline diamond or copper.

29. The method of claim 24, wherein the thermally-conductive element includes an annular portion surrounding at least a portion of the substrate and includes at least one of polycrystalline diamond or copper.
